(19) United States
(12) Patent Application Publication
(10) Pub. No.: US 2008/0212113 A1
(43) Pub. Date: Sep. 4, 2008

(54) HOST DEVICE HAVING A PRINTER DRIVER AND CONTROL METHOD OF THE PRINTER DRIVER

(75) Inventor: JOO DUCK KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/970,627

(22) Filed: Jan. 8, 2008

(30) Foreign Application Priority Data
Jan. 9, 2007 (KR) 2007-2629
Nov. 1, 2007 (KR) 2007-111042

(51) Int. Cl. G06F 15/00; G06F 3/12

(52) U.S. Cl. 358/1.9; 358/1.15; 358/1.13

(57) ABSTRACT

A printer driver and a method of controlling the same are disclosed. If the printer driver ICC profile does not correspond to the printer ICC profile, the printer driver converts color information of an image into predetermined information using the printer ICC profile instead of the printer driver ICC profile, such that the image forming apparatus can reproduce an optimum color as close to the original color of the image. The control method for the printer driver contained in a computer connected to an image forming apparatus includes determining whether an ICC profile of the image forming apparatus corresponds to an ICC profile established in the printer driver, and if the ICC profile of the image forming apparatus does not correspond to the ICC profile established in the printer driver, converting color information of the image into predetermined information using the ICC profile of the image forming apparatus.

### CROSS-REFERENCE TO RELATED APPLICATION

This application claims the benefit of Korean Patent Application No. 2007-2629, filed in the Korean Intellectual Property Office on Jan. 9, 2007 and Korean Patent Application No. 2007-111042, filed in the Korean Intellectual Property Office on Nov. 1, 2007, the disclosures of which are incorporated herein by reference.

### BACKGROUND OF THE INVENTION

1. Field of the Invention

Example embodiments of the present invention relate to a host device having a printer driver, and control methods of the printer driver, and more particularly to a host device having a printer driver capable of converting color information of a color image to be printed into color information for a printer using an International Color Consortium (ICC) profile, and control methods of the printer driver.

2. Description of the Related Art

Generally, when a user desires to print colors of an image displayed on a monitor to a paper or a medium using a color printer without any change, a printer driver is required to perform the above-mentioned function. A color document or a color image created by the user can be represented by CMYK or RGB colors. In these cases, the RGB colors are indicative of a color system composed of Red (R), Green (G), and Blue (B) colors, and the CMYK colors are indicative of a color system composed of Cyan (C), Magenta (M), Yellow (Y), and Black (K) colors.

The color information of the color image is converted into standard RGB (sRGB) color information by an application program. The printer driver converts the sRGB color information into CMYK color information for a printer using an International Color Consortium (ICC) profile.

The most important thing that greatly affects image quality of color-printed object is converting the sRGB information into the CMYK color information for the printer. In other words, in order to properly perform the color conversion of the sRGB information, a color printing operation must be executed at a high degree of saturation and a high degree of contrast. For this purpose, the color conversion is executed by the ICC profile indicative of a color-reproduction profile.

Presently, many display device companies in the world have established the International Color Consortium (ICC) Organization, and have stored color characteristics of color displays manufactured by individual display device companies according to specific specifications. Accordingly, if unique color reproduction characteristics of individual display devices are to be expressed according to the above-mentioned specifications, the ICC profile thereof is acquired.

Many printer device companies have provided different printer ICC profiles, such that the printer ICC profiles have unique color reproduction characteristics of individual printer device companies.

In the case of performing the color conversion from the sRGB to the CMYK using an ICC profile established in a printer driver (hereinafter referred to as a printer driver ICC profile), the ICC profile of the printer driver must be equal to a unique ICC profile of a printer (hereinafter referred to as a printer ICC profile) to prevent a quality of a printed color image from being deteriorated.

However, the ICC profile established in the printer driver may not be equal to the unique ICC profile of the printer. In this case, the printer cannot output optimum color characteristics of the printer driver, resulting in a deterioration of color image quality.

### SUMMARY OF THE INVENTION

Aspects of the invention provide a host device having a printer driver capable of effectively reproducing a color of an image printed by an image forming apparatus, so that the reproduced color image closely matches an original color of an object from which the image is formed, and a control method of the printer driver.

Additional aspects and/or advantages of the invention will be set forth in part in the description which follows and, in part, will be obvious from the description, or may be learned by practice of the invention.

In accordance with an example embodiment of the present invention, the above and/or other aspects can be achieved by the provision of a method of controlling a printer driver contained in a computer connected to an image forming apparatus, the method includes determining whether an International Color Consortium (ICC) profile of the image forming apparatus corresponds to an ICC profile established in the printer driver; and if the ICC profile of the image forming apparatus does not correspond to the ICC profile established in the printer driver, converting color information of an image to be printed into predetermined information using the ICC profile of the image forming apparatus.

In accordance with an example embodiment of the present invention, the method further includes: after performing the determining operation, if the ICC profile of the image forming apparatus does not correspond to the ICC profile established in the printer driver, generating a warning message indicating that the color information of the image to be printed may be different from that of a printed resultant image once the color information is converted.

In accordance with an example embodiment of the present invention, the method further includes: informing a user whether the ICC profile of the image forming apparatus corresponds to the ICC profile established in the printer driver.

In accordance with an example embodiment of the present invention, the method further includes: after performing the determining operation, if the ICC profile of the image forming apparatus corresponds to the ICC profile established in the printer driver, converting the color information of the image to be printed into the predetermined information using the ICC profile of the printer driver.

In accordance with an example embodiment of the present invention, the method further includes: after performing the converting operation, converting the image converted into the color information into languages capable of being interpreted by the image forming apparatus, and transmitting the converted result to the image forming apparatus.

In accordance with an example embodiment of the present invention, the method further includes: before the determining operation, requesting the ICC profile of the image forming apparatus, and receiving the requested ICC profile of the image forming apparatus.

In accordance with another example aspect of the present invention, there is provided a method of controlling a printer driver contained in a computer connected to an image forming apparatus, the method includes: determining whether a first International Color Consortium (ICC) profile of the image forming apparatus corresponds to a second ICC profile established in the printer driver; if the first ICC profile of the image forming apparatus does not correspond to the second ICC profile established in the printer driver, receiving a selected ICC profile to be used for color conversion from among the first and second ICC profiles; and converting color information of an image to be printed into predetermined information using the received selected ICC profile.

In accordance with an example embodiment of the present invention, the converting operation includes: if the selected ICC profile from among the first and second ICC profiles corresponds to the second ICC profile during the conversion of the color information, generating a warning message indicating that the color of the image to be printed may be different from that of a printed resultant image once the color information is converted.

In accordance with yet another example embodiment of the present invention, there is provided a method of controlling a printer driver contained in a computer connected to an image forming apparatus, the method includes: requesting an International Color Consortium (ICC) profile of the image forming apparatus, and receiving the requested ICC profile of the image forming apparatus; converting color information of an image to be printed using the received ICC profile of the image forming apparatus; and transmitting converted color information to the image forming apparatus.

In accordance with yet another example embodiment of the present invention, there is provided a host device having a printer driver, and connected to an image forming apparatus, including: a storage unit to store an International Color Consortium (ICC) profile of the printer driver; and a driver controller to determine whether the ICC profile of the image forming apparatus corresponds to an ICC profile of the printer driver, and to convert color information of an image to be printed into predetermined information using the ICC profile of the image forming apparatus if the ICC profile of the image forming apparatus does not correspond to the ICC profile of the printer driver.

In accordance with an example embodiment of the present invention, if the ICC profile of the image forming apparatus does not correspond to the ICC profile of the printer driver, the driver controller generates a warning message indicating that the color of the image to be printed may be different from that of a printed resultant image once the color information is converted.

In accordance with an example embodiment of the present invention, the driver controller indicates whether the ICC profile of the image forming apparatus corresponds to the ICC profile of the printer driver.

In accordance with an example embodiment of the present invention, if the ICC profile of the image forming apparatus does not correspond to the ICC profile of the printer driver, the driver controller enables selection of any one of the two ICC profiles.

In accordance with an example embodiment of the present invention, the driver controller, if the ICC profile of the image forming apparatus corresponds to the ICC profile of the printer driver, converts the color information of the image to be printed into the predetermined information using the ICC profile of the printer driver.

In accordance with an example embodiment of the present invention, a system to convert standard RGB (sRGB) color of an image into CMYK color information to reproduce the image on a medium, includes an image forming apparatus to reproduce the image on the medium, and having a first International Color Consortium (ICC) profile; and a host including a printer driver and a driver controller, and having a second ICC profile, wherein the driver controller determines whether the first ICC profile corresponds to the second ICC profile, and uses the second ICC profile to convert color information of the image into CMYK color information if the first and second ICC profiles correspond so that the image forming apparatus reproduces the image on the medium using the CMYK color information.

In accordance with an example embodiment of the present invention a method of converting standard RGB (sRGB) color of an image into CMYK color information to reproduce the image on a medium, includes determining whether a first ICC profile of an image forming apparatus corresponds to a second ICC profile of a printer driver converting color information of the image into CMYK color information using the second ICC profile if the first and second ICC profiles correspond; and reproducing the image on the medium using the CMYK color information on the medium.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating a printing system with a printer driver according to an example embodiment of the present invention; and

FIG. 2 is a flow chart illustrating a method of controlling the printer driver of FIG. 1.

### DETAILED DESCRIPTION OF THE EMBODIMENTS

Reference will now be made in detail to embodiments of the present invention, examples of which are illustrated in the accompanying drawings, wherein like reference numerals refer to like elements throughout. The example embodiments are described below to explain the present invention by referring to the figures.

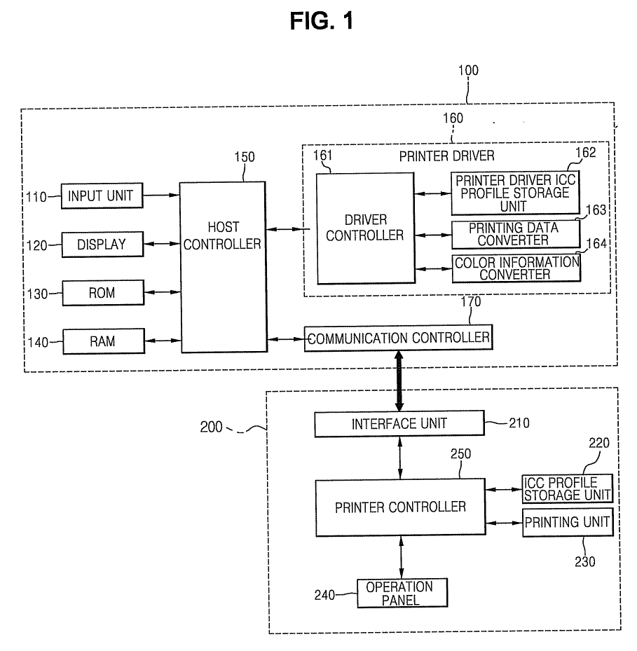

FIG. 1 is a block diagram illustrating a printing system with a printer driver according to an example embodiment of the present invention. Referring to FIG. 1, the printing system includes a host computer 100 and a printer 200. The host computer 100 transmits a printing command and printing data to the printer 200 in order to command the printer 200 to print a desired color image. The printer 200 prints the desired color image on a paper or a medium upon receiving the printing command and the printing data from the host computer 100.

The host computer 100 includes an input unit 110, a display 120, a ROM (Read Only Memory) 130, a RAM (Random Access Memory) 140, a host controller 150, a printer driver 160, and a communication controller 170, for example. The input unit 110 acts as a user interface, so that the user can establish a variety of functions supported by the host computer 100 using the input unit 110. For example, a keyboard or a mouse may be used as the input unit 110. Accordingly, the user inputs a variety of commands required to operate the system to the computer 100 using the keyboard or the mouse, such that the commands are transmitted to the host controller (or a CPU, Central Processing Unit) 150 via a system bus (represented as an arrow).

The display 120 also acts as a user interface. The user may visually recognize a variety of programs implemented by the host computer 100 via characters or graphic data displayed on the display 120. A cathode ray tube (CRT) or a liquid crystal display (LCD) may be used as the above-mentioned display 120, but the types of the display are not limited thereto. The user can visually recognize program implementation status and results by referring to the UI (User Interface) window displayed on the display 120. In various example embodiments, the UI window may be a graphics user interface (GUI), for example.

The ROM 130 acts as a non-volatile memory that preserves its own stored data although the host computer 100 may be powered off. The ROM 130 stores a control program (e.g., an operating system (OS)) to implement functions of the host computer 100 and/or a variety of application programs. In various example embodiments, the display 120 may be a touch pad display and/or a flat panel display.

The RAM 140 acts as a volatile memory that stores a variety of data created during execution of the control program and/or the variety of the application programs. The printer driver 160 controls printing operations of the printer 200. The printer driver 160 includes a driver controller 161, a printer driver ICC profile storage unit 162, a printing-data converter 163, and a color-information converter 164. As shown in FIG. 1, the printer-driver ICC profile storage unit 162 stores a printer driver ICC profile that has been currently established for the printer driver 160.

The printing-data converter 163 converts printing data of a color image to be printed into a printer-language format capable of being interpreted by the printer 200. The color-information converter 164 converts color information of a color image to be printed into YMCK color information for the printer 200.

The driver controller 161 controls conversion of the printing data of the color image to be printed into the printer language format capable of being interpreted by the printer 200 during a printing mode. Also, in order to convert the color information of the color image to be printed into another color information (via the color-information converter 164), the driver controller 161 requests the printer ICC profile from the printer 200, receives the printer ICC profile, and determines whether the received printer ICC profile is equal to (corresponds to or matches) the printer driver ICC profile. In this case, the driver controller 161 may inform the user whether the two ICC profiles (that is, the printer ICC profile and the printer driver ICC profile) are equal to each other, as necessary.

If the two ICC profiles are equal to (corresponds to or match) each other, the driver controller 161 controls conversion of the color information of the color image to be printed into printer color information using the printer driver ICC profile, and controls transmission of the printer color information along with the printing data having printer languages capable of being interpreted by the printer 200, to the printer 200.

Otherwise, if the two ICC profiles are different from (or do not match) each other, the driver controller 161 controls the display of a warning message on the display 120. In this case, the warning message indicates that the color of the color image to be printed may be different from that of an actual color-printed result because the two ICC profiles are different from each other. Thereafter, the driver controller 161 queries the user whether to perform the printing operation using the printer driver ICC profile or the printer ICC profile. Thereafter, the driver controller 161 continues to control the conversion of the color information using the user-selected ICC profile.

If the user desires the conversion of the color information using the printer ICC profile instead of the printer driver ICC profile, the driver controller 161 controls conversion of the color information of the color image to be printed into printer color information using the printer ICC profile, and controls transmission of the printer color information along with the printing data based on the printer language capable of being interpreted by the printer 200, to the printer 200. Therefore, the color of the color image to be printed can be reproduced on the paper (or the medium) without any change, so that there is little difference between the color of the color image to be printed and the color of the printed result. That is, the color of the color image to be printed would be reproduced on the paper or the medium accurately.

In the meantime, if the user desires conversion of the color information into another color information using the printer driver ICC profile, the driver controller 161 controls the conversion of the color information of the color image to be printed into the printer color information using the printer driver ICC profile, and controls the transmission of the printer color information along with the printing data based on the printer language capable of being interpreted by the printer 200, to the printer 200. In this case, the original color of the color image to be printed cannot be reproduced on the paper (or the medium) without any change for there to be little difference between the color of the color image to be printed and the color of the printed result. That is, the color of the color image to be printed would not be reproduced on the paper or the medium accurately. In this case further color adjustment may be performed. Although the driver controller 161 is discussed as controlling the printing data converter 163, the color information converter 164, and functions thereof, in other example embodiments, the driver controller 161 may include the printing data converter 163 and the color information converter 164, or their functionality.

As shown in FIG. 1, the communication controller 170 can be connected to the printer 200, and supports a communication interface for the printer 200. The host controller 150 reads a control program stored in the ROM 130, and controls operations of the host computer 100. Also, the host controller 150 performs a variety of functions via an application program to be implemented by the user, and stores printing data created during operation of the application program in the RAM 140. Particularly, the host controller 150 drives the printer driver 160 to control operations of the printer 200.

The printer 200 includes an interface 210, an ICC profile storage unit 220, a printing unit 230, an operation panel 240, and a printer controller 250, for example. The interface 210 can be connected to the host computer 100, and supports a communication interface of the host computer 100.

The ICC profile storage unit 220 stores the printer ICC profile having unique color-reproduction characteristics of the printer 200. The printing unit 230 prints printing data and color information on a paper (or a medium) according to a control signal of the printer controller 250.

The operation panel 240 includes an operation unit (not shown) and an LCD display (not shown), and transmits a user command received from the operation unit to the printer controller 250. The operation panel 240 displays statuses of the printer 200 on the LCD display according to a control signal of the printer controller 250.

The printer controller 250 controls the printing unit 230 upon receiving the printing command from the printer driver 160, and prints the color image on the paper (or the medium) according to the printing data and the color information. Particularly, the printer controller 250 transmits the printer ICC profile stored in the ICC profile storage unit 220 to the printer driver 160 upon receiving a request from the printer driver 160.

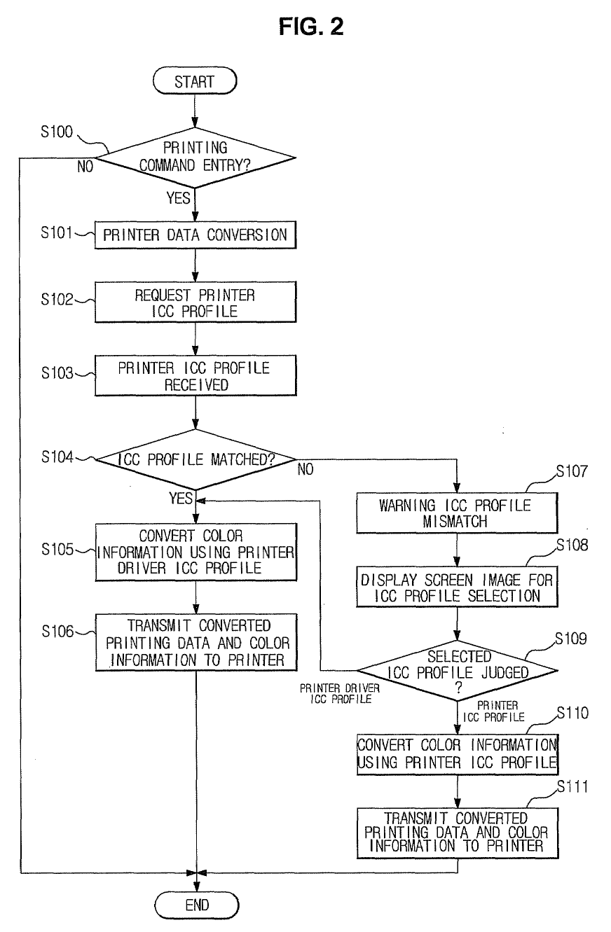

FIG. 2 is a flow chart illustrating a method of controlling a printer driver of FIG. 1. Referring to FIG. 2, the printer driver 160 determines whether a user enters a printing command for a color image to be printed at operation S100. If the user enters the printing command at operation S100, the printer driver 160 converts (or controls the conversion of) printing data of the color image to be printed into printer languages capable of being interpreted by the printer 200 using the printing data converter 163 at operation S101.

The printer driver 160 requests a printer ICC profile from the printer 200 at operation S102. Therefore, the printer 200 transmits the printer ICC profile stored in the ICC profile storage unit 220 to the printer driver 160.

The printer driver 160 receives the printer ICC profile from the printer 200 at operation S103. Thereafter, the printer driver 160 determines whether a printer driver ICC profile established in the printer driver 160 is equal to the printer ICC profile received from the printer 200 at operation S104. In this case, the printer diver 160 may inform the user whether the two ICC profiles are equal to (or match) each other.

If the two ICC profiles are equal to (or match) each other at operation S104, the printer driver 160 converts or commands the color information converter 164 to convert color information of the color image to be printed into printer color information using the printer driver ICC profile. Also, the printer color information and the printing data based on printer languages capable of being interpreted by the printer 200 are transmitted to the printer 200 at operation S106.

In the meantime, if the two ICC profiles are different from each other at operation S105, the printer driver 160 transmits a warning message to the display 120. The warning message indicates that the color of the color image to be printed may be different from that of the color-printed result because the two ICC profiles are different from each other.

Thereafter, the printer driver 160 displays a screen image on the display 120 on which any one of the two ICC profiles can be selected at operation S108, whereby the printer driver 160 queries the user whether to perform the printing operation using the printer driver ICC profile or the printer ICC profile received from the printer 200. Then, the printer driver 160 determines whether the user-selected ICC profile is indicative of the printer driver ICC profile or the printer ICC profile.

If the user-selected ICC profile is indicative of the printer driver ICC profile at operation S108, the printer driver 160 converts or controls the conversion of the color information of the color image to be printed into printer color information using the printer driver ICC profile at operation S105, and transmits or controls the transmission of the printer color information to the printer 200 along with the printing data based on printer languages capable of being interpreted by the printer 200 at operation S106. In this case, the color of the color image to be printed cannot be reproduced on the paper or the medium without any change, such that there is a little difference between the color of the color image to be printed and the color of the printed result. That is, the color of the color image to be printed would not be reproduced on the paper or the medium accurately. In this case further color adjustment may be performed.

If the user-selected ICC profile is indicative of the printer ICC profile at operation S109, the printer driver 160 converts or controls the conversion of the color information of the color image to be printed into printer color information using the printer ICC profile at operation S110, and transmits or controls the transmission of the printer color information to the printer 200 along with the printing data based on printer languages capable of being interpreted by the printer 200. In this case, the color of the color image to be printed can be reproduced on the paper or the medium without any change, such that there is little difference between the color of the color image to be printed and the color of the printed result. That is, the color of the color image to be printed would be reproduced on the paper or the medium accurately.

Although the above-mentioned example embodiment of the present invention is disclosed in a context of a printer driver, which can allow the user to select either the printer driver ICC profile or the printer ICC profile when two ICC profiles are different from each other, and without automatically converting the color information of the color image to be printed into printer color information using the printer ICC profile, the scope and spirit of the present invention is not limited to the above-mentioned example embodiments and can be applied to other examples. In addition, although the two ICC profiles are different from each other, the printer driver according to example embodiments of the present invention can also automatically convert the color information of the color image to be printed into printer color information using the printer ICC profile.

As is apparent from the above description, if the printer driver ICC profile is not equal to the printer ICC profile, the printer driver according to the example embodiments of the present invention converts color information of the color image to be printed into predetermined information using the printer ICC profile instead of the printer driver ICC profile, such that the color of the image to be printed can be reproduced on the paper or the medium for use in the color printer without any change or difference.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, although discussed in terms of a color printer, any image forming apparatus is within the scope of the invention. Also, although the driver controller 161 is discussed as controlling the printing data converter 163, the color information converter 164, and functions thereof, in other example embodiments, the driver controller 161 may include the printing data converter 163 and the color information converter 164, or their functionality. In example embodiments, the printer driver may be a software or a firmware.

Accordingly, it is intended, therefore, that the present invention not be limited to the various example embodiments disclosed, but that the present invention includes all embodiments falling within the scope of the appended claims.

What is claimed is:

1. A method of controlling a printer driver contained in a host connected to an image forming apparatus, the method comprising:
determining whether an International Color Consortium (ICC) profile of the image forming apparatus corresponds to an ICC profile established in the printer driver; and
if the ICC profile of the image forming apparatus does not correspond to the ICC profile established in the printer driver, converting color information of an image to be printed into predetermined information using the ICC profile of the image forming apparatus.

2. The method according to claim 1, further comprising: after performing the determining operation, if the ICC profile of the image forming apparatus does not correspond to the ICC profile established in the printer driver, generating a warning message indicating that the color information of the image to be printed may be different from that of a printed resultant image once the color information is converted.

3. The method according to claim 1, further comprising:
informing a user whether the ICC profile of the image forming apparatus corresponds to the ICC profile established in the printer driver.

4. The method according to claim 1, further comprising: after performing the determining operation, if the ICC profile of the image forming apparatus corresponds to the ICC profile established in the printer driver, converting the color information of the image to be printed into the predetermined information using the ICC profile of the printer driver.

5. The method according to claim 1, further comprising: after performing the converting operation, converting the image converted into the color information into languages capable of being interpreted by the image forming apparatus, and transmitting the converted result to the image forming apparatus.

6. The method according to claim 1, further comprising:
before the determining operation, requesting the ICC profile of the image forming apparatus, and receiving the requested ICC profile of the image forming apparatus.

7. A method of controlling a printer driver contained in a computer connected to an image forming apparatus, the method comprising:
determining whether a first International Color Consortium (ICC) profile of the image forming apparatus corresponds to a second ICC profile established in the printer driver;
if the first ICC profile of the image forming apparatus does not correspond to the second ICC profile established in the printer driver, receiving a selected ICC profile to be used for color conversion from among the first and second ICC profiles; and
converting color information of an image to be printed into predetermined information using the received selected ICC profile.

8. The method according to claim 7, wherein the converting operation includes:
if the selected ICC profile corresponds to the second ICC profile, generating a warning message indicating that the color of the image to be printed may be different from that of a printed resultant image once the color information is converted.

9. A host device having a printer driver, and connected to an image forming apparatus, comprising:
a storage unit to store an International Color Consortium (ICC) profile of the printer driver; and
a driver controller to determine whether the ICC profile of an image forming apparatus corresponds to an ICC profile of the printer driver, and to convert color information of an image to be printed into predetermined information using the ICC profile of the image forming apparatus if the ICC profile of the image forming apparatus does not correspond to the ICC profile of the printer driver.

10. The printer driver according to claim 9, wherein the driver controller, if the ICC profile of the image forming apparatus does not correspond to the ICC profile of the printer driver, generates a warning message indicating that the color of the image to be printed may be different from that of a printed resultant image once the color information is converted.

11. The printer driver according to claim 9, wherein the driver controller indicates whether the ICC profile of the image forming apparatus corresponds to the ICC profile of the printer driver.

12. The printer driver according to claim 9, wherein the driver controller, if the ICC profile of the image forming apparatus does not correspond to the ICC profile of the printer driver, enable selection of any one of the two ICC profiles.

13. The printer driver according to claim 9, wherein the driver controller, if the ICC profile of the image forming apparatus corresponds to the ICC profile of the printer driver, converts the color information of the image to be printed into the predetermined information using the ICC profile of the printer driver.

14. A system to convert standard RGB (sRGB) color of an image into CMYK color information to reproduce the image on a medium, comprising:
an image forming apparatus to reproduce the image on the medium, and having a first International Color Consortium (ICC) profile; and
a host including a printer driver and a driver controller, and having a second ICC profile, wherein the driver controller determines whether the first ICC profile corresponds to the second ICC profile, and uses the second ICC profile to convert color information of the image into CMYK color information if the first and second ICC profiles correspond so that the image forming apparatus reproduces the image on the medium using the CMYK color information.

15. The system of claim 14, wherein if the first and second ICC profiles do not correspond, the driver controller uses the first ICC profile or the second ICC profile to convert color information of the image into CMYK color information based on a received selection.

16. A method of converting standard RGB (sRGB) color of an image into CMYK color information to reproduce the image on a medium, comprising:
determining whether a first ICC profile of an image forming apparatus corresponds to a second ICC profile of a printer driver;
converting color information of the image into CMYK color information using the second ICC profile if the first and second ICC profiles correspond; and
reproducing the image on the medium using the CMYK color information on the medium.

17. The method of claim 16, wherein if the first and second ICC profiles do not correspond, converting color information of the image into CMYK color information based on a selected one of the first ICC profile or the second ICC profile.
